(19) United States
(12) Patent Application Publication
(10) Pub. No.: US 2014/0040141 A1
(43) Pub. Date: Feb. 6, 2014

(54) USE OF CHECK-FACE META-DATA FOR ENHANCED TRANSACTION PROCESSING

(71) Applicants: Timmy L. Gauvin, Atlanta, GA (US); Kerry M. Cantley, Fort Mill, SC (US); James G. Ronca, Decatur, GA (US); Leslie M. LaRock, Davidson, NC (US)

(72) Inventors: Timmy L. Gauvin, Atlanta, GA (US); Kerry M. Cantley, Fort Mill, SC (US); James G. Ronca, Decatur, GA (US); Leslie M. LaRock, Davidson, NC (US)

(73) Assignee: Bank of America Corporation, Charlotte, NC (US)

(21) Appl. No.: 13/564,971

(22) Filed: Aug. 2, 2012

(51) Int. Cl. G06Q 40/02

(52) U.S. Cl. 705/45

(57) ABSTRACT

A computer-readable media storing computer-executable instructions for using a check deposit device to process a check is provided. The method derives meta-data from the check. The check deposit device may use an image receiver device to obtain a check image from the check. The method may use the processor to define a plurality of check segments within the check image. The processor device may obtain content from each of the plurality of check segments. The processor device may be store the content of each of the check segments in a machine readable memory and may utilize a transmitter to transmit the content from the plurality of check segments to a check-clearance engine. The check deposit device may receive from the check-clearance engine, in response to the transmission of the portion of the content from the plurality of check segments, an indication of the sufficiency of funds in an account.

### FIELD OF TECHNOLOGY

This application relates to check content utilization. More specifically, the application relates to expediting handling of check content information.

### BACKGROUND OF THE INVENTION

Checks contain a substantial amount of information. Processing information on checks may be relatively time-consuming and, at times, may require high processing overhead. Such overhead may take the form of repeatedly performing processing steps. Such overhead may also involve relatively high use of computer processor time.

In some instances, such processing may be forced to occur during low activity periods, such as during non-banking hours, in order to maximize available computer processing resources. Such scheduling may increase check processing times.

It would therefore be desirable to provide apparatus and methods for expediting check content processing.

### SUMMARY OF THE INVENTION

Apparatus, methods and media for apparatus and methods for expediting check content processing are provided. An apparatus may include an image receiver device that is configured to receive a check image. The apparatus may also include a processor device that is configured to: define a plurality of check segments within the check image; obtain content from each of the plurality of check segments; and store the content of each of the plurality of check segments in a machine readable memory. The apparatus may also include a transmitter that is configured to transmit the content from at least a portion of the plurality of check segments to a check-clearance engine. The check deposit device may also include a data receiver device that is configured to receive from the check-clearance engine, in response to the transmission of the portion of the content from the plurality of check segments, an indication of the sufficiency of funds in an account associated with the check relative to the amount of the check.

### BRIEF DESCRIPTION OF THE DRAWINGS

The objects and advantages of the invention will be apparent upon consideration of the following detailed description, taken in conjunction with the accompanying drawings, in which like reference characters refer to like parts throughout, and in which:

FIG. 1 shows illustrative information in accordance with the principles of the invention;

FIG. 2 shows an illustrative source of information that may be used in accordance with the principles of the invention;

FIG. 3 shows another illustrative source of information that may be used in accordance with the principles of the invention;

FIG. 4 shows illustrative apparatus in accordance with the principles of the invention;

FIG. 5 shows illustrative elements of a process in accordance with the principles of the invention;

FIG. 6 shows illustrative elements of another process in accordance with the principles of the invention;

FIG. 7 shows illustrative elements of yet another process in accordance with the principles of the invention; and

FIG. 8 shows other illustrative information in accordance with the principles of the invention.

### DETAILED DESCRIPTION OF THE DISCLOSURE

As will be appreciated by one of skill in the art, the invention described herein may be embodied in whole or in part as a method, a data processing system, or a computer program product. Accordingly, the invention may take the form of an entirely hardware embodiment, an entirely software embodiment or an embodiment combining software, hardware and any other suitable approach or apparatus.

Furthermore, such aspects may take the form of a computer program product stored by one or more computer-readable storage media having computer-readable program code, or instructions, embodied in or on the storage media. Any suitable computer readable storage media may be utilized, including hard disks, CD-ROMs, optical storage devices, magnetic storage devices, and/or any combination thereof. In addition, various signals representing data or events as described herein may be transferred between a source and a destination in the form of electromagnetic waves traveling through signal-conducting media such as metal wires, optical fibers, and/or wireless transmission media (e.g., air and/or space).

Apparatus for check-face meta-data processing is provided. The apparatus may include an image receiver device that is configured to receive a check image. The apparatus may include a processor device. The processor device may be understood to include one or more than one processors.

The processor device may be configured to define a plurality of check segments within the check image. The processor device may be further configured to obtain content from each of the plurality of check segments and to store the content of each of the plurality of check segments in a machine readable memory.

The apparatus may also include a transmitter that is configured to transmit the content from at least a portion of the plurality of check segments to a check-clearance engine.

The apparatus may also include a data receiver device that is configured to receive from the check-clearance engine an indication of the sufficiency of funds in an account associated with the check relative to the amount of the check. The data receiver device may preferably receive the indication in response to the transmission of the portion of the content from the plurality of check segments.

In some embodiments of the invention, the plurality of check segments may include at least three check segments.

In some embodiments of the invention, the plurality of check segments may include a check number segment. The plurality of check segments may also include an account identifier segment.

The plurality of check segments may also include a payee segment and a payee family segment. The plurality of check segments may also include a check date segment.

The plurality of check segments may include a dollars segment. The plurality of check segments may also include a signature segment.

The plurality of check segments may also include a scan location segment.

Some embodiments may include a cash dispenser device. In such embodiments a processor in the apparatus may be further configured to instruct the cash dispenser device to dispense cash.

The cash dispenser device may be instructed to dispense cash in response, at least in part, to a data receiver device receiving confirmation of sufficiency of funds. The cash dispenser device may also be instructed to dispense cash in response, at least in part, to receiving a user request to dispense cash.

Some embodiments may include a deposit device. The processor may be further configured to instruct the deposit device to deposit funds corresponding to an amount of funds written on the check.

The deposit device and/or the check clearance engine may be, either individually or together, configured to initiate a transfer of funds from the drawer's bank to the payee's bank pursuant to specifications of the check. For example, the deposit device and/or the check clearance engine may effect a transfer of funds from the account associated with the check to an account specified by the payee. The transfer may be based, at least in part, on meta-data obtained from the check image.

The deposit device and/or the check clearance engine may be, either individually or together, configured to deposit funds in a predetermined account in response, at least in part, to the data receiver device receiving confirmation of sufficiency of funds in the account upon which the check is drawn. The deposit device may also be configured to deposit funds in a predetermined account in response, at least in part, to receiving a user request to deposit funds corresponding to an amount of funds written on the check.

The processor may be further configured, upon receipt of identification of the drawer and, preferably, upon receipt of confirmation of sufficiency of funds in the drawer's account, to convert a check transaction into an automated clearinghouse (“ACH”) transaction.

The ACH is a computer network of financial institutions that carries out the great majority of electronic transactions. Whereas a check is currently typically handled through delivery, either physically or electronically, to the drawee bank, an ACH is different. The entity that makes an electronic payment using ACH is the “receiver.” The “originator” is the retailer or any other entity whose devices are sued to swipe a card or otherwise initiate an ACH.

Following receipt of authorization by the receiver, the originator instructs their bank to make a claim against the receiver's bank for the authorized amount. The originator's bank then makes a claim against the receiver's bank. The receiver's bank then debits the funds from the receiver's account. If the receiver's funds are sufficient to cover the authorized amount, the originator's bank is authorized to make a credit in the originator's account and the funds are thus made available.

At least because embodiments of apparatus include the capability of determining, substantially in real time, account sufficiency with respect to the check, it follows that a real-time conversion of the check to an ACH transaction is also supported.

In such a transaction, the following process may be implemented. First, a user may deposit a check at an ATM, a portable check cashing device including a scanner, an application on a smart phone equipped with scanning or other imaging equipment or at any other suitable device (referred to collectively herein, without limitation, as “check deposit device.”)

Thereafter, the check deposit device may obtain an image of the check. The check deposit device may obtain information from the image of the check. Such information obtained from the check may include check number, account identifier, payee, payee family, check date, check amount, dollars, comment, comment family, signature and/or scan location.

The check deposit device may then, substantially in real time, use the information from the check. Specifically, the check deposit device may use the information from the check to determine whether the account at the drawee bank that is associated with the check includes sufficient funds to cover the check.

In one embodiment, the check deposit device may transmit, using a check clearance engine, at least a portion of the information from the check to a central location. At the central location, the information on the check may be used to verify that sufficient funds to cover the check exist in the account at the drawee bank that is associated with the check.

In order to verify that sufficient funds are available, the central location should preferably be in communication with the drawee bank.

Following transmission of the at least a portion of the information from the check to a central location, the central location may be configured to receive a transmission from the drawee bank to verify that sufficient funds to cover the check exist in the account at the drawee bank that is associated with the check.

Thereafter, the central location should preferably transmit a communication, either directly or indirectly, to the check deposit device, preferably via the check clearance engine. The check clearance engine should preferably be configured to receive such a transmission.

It should be noted that the check deposit device may incorporate—i.e., include as a component part—the check clearance engine. The check deposit device may be separate from the check clearance engine. The check clearance engine may be in communication with the check deposit device such that the check clearance engine receives information from the check deposit device and then, in turn, communicates with the central location to determine whether the check can clear.

Upon receipt of such a transmission, the check deposit device should preferably be configured to display a visual indication as to whether sufficient funds exist in the account at the drawee bank that is associated with the check. The check deposit device may also be adapted to communicate, preferably to the check depositor, via a visual indicator, such as a graphical user interface (“GUI”) and/or an audio communication whether sufficient funds exist in the account at the drawee bank that is associated with the check—e.g., identified on the check.

In certain embodiments of the check deposit device—e.g., the ATM embodiment described above—the check deposit device may preferably be configured to immediately release funds in an amount that corresponds to the amount of funds in the check. The release may preferably occur in response to the receipt of information from the central location that sufficient funds exist in the account to cover the check. Such release preferably draws down funds associated with the drawer's account at the drawee bank.

In certain embodiments of the check deposit device and/or the check clearance engine, the check deposit device may preferably be configured to immediately convert the amount of funds that corresponds to the amount of funds in the check into an ACH transaction, a wire transaction or other suitable transaction, from the drawer—i.e., the person or entity who makes the check—to the payee—i.e., the recipient of the funds.

In certain embodiments, the check-clearance engine may be in direct communication with a drawee bank upon which the funds in the check are drawn.

Illustrative embodiments of apparatus and methods in accordance with the principles of the invention will now be described with reference to the accompanying drawings, which form a part hereof. It is to be understood that other embodiments may be utilized and structural, functional and procedural modifications may be made without departing from the scope and spirit of the present invention.

In certain embodiments, the check-clearance engine may be in direct communication with the drawee bank and may use communications that conform to the X9-37 standard for check imaging. Such a standard may be used in capturing images and data. The standard is typically used after running checks through high-speed sorters and obtaining the MiCR information and the check image. X9-37 files are typically used instead of paper checks.

Thereafter, the standard may be used in packaging the data—e.g., MiCR information and check image information. In typical interbank communications regarding clearing of checks, the X9-37 standard is leveraged by the transmitting bank to format the data for transmission together with a cash letter—i.e., a paper listing a group of checks sent to a clearing house or the Federal Reserve check collection system—and transmit the cash letter for receipt by the drawee bank. The cash letter contains a number of negotiable items, mostly checks, accompanied by a letter that lists the check amounts and instructions for transmittal to other banks.

The drawee bank typically uses the X9-37 standard to deconstruct the data accompanying the cash letter in order to reproduce the information as necessary for drawing down the respective drawers' account.

In certain embodiments, the check deposit device may use the X9-37 standard to control the derivation of meta-data from the check, for transmitting the meta-data to a bank, for deconstructing the received data at the bank and for transmitting the determination of whether sufficient funds exist in the account to the check deposit device.

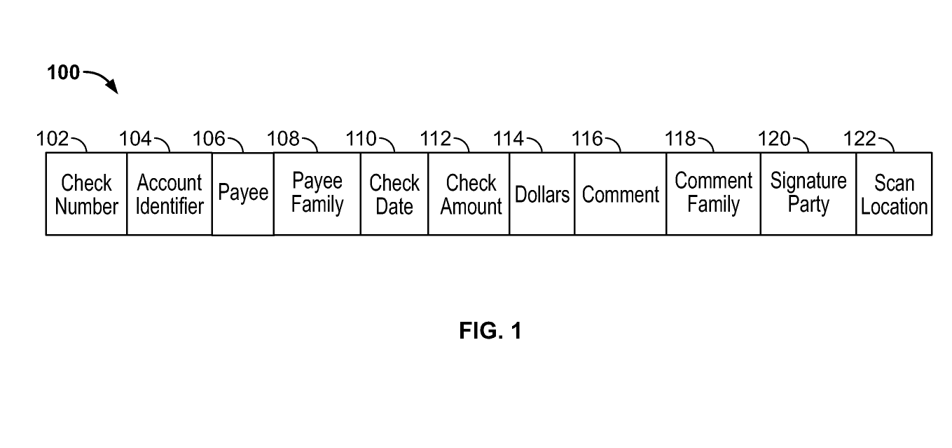

FIG. 1 shows transaction record 100. Transaction record 100 may include one or more fields such as check number 102, account identifier 104, payee 106, payee family 108, check date 110, check amount 112, dollars 114, comment 116, comment family 118, signature 120 and scan location 122.

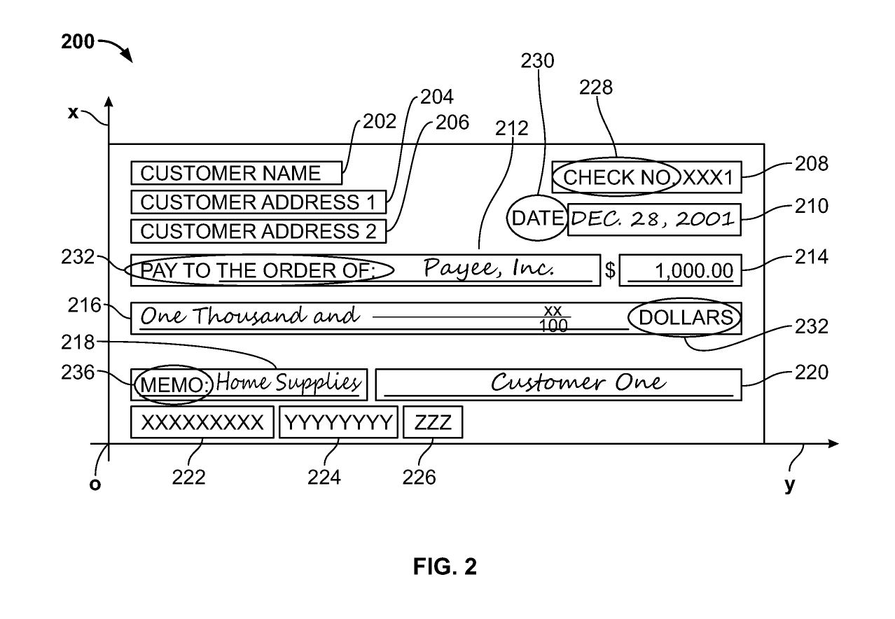

FIG. 2 shows illustrative front check image 200. Check image 200 may include one or more segments. Each segment may correspond to a type of information that is included on the front of a check. In FIG. 2, check segments are identified by rectangular boxes. For example, check image 200 may include one or more of customer name segment 202, customer address 1 segment 204, customer address 2 segment 206, check number segment 208, date segment 210, payee segment 212, amount segment 214, dollars segment 216, comment segment 218, signature segment 220, routing number segment 222, account number segment 224, check number segment 226 and any other suitable segments.

Check image 200 may include one or more field identifiers. Each field identifier may correspond to a type of information that is displayed on the check to identify a check segment. For example, check image 200 may include one or more of “check number” field identifier 228, “date” field identifier 230, “pay-to-the-order-of” field identifier 232, “dollars” field identifier 234, “memo” field identifier 236 and any other suitable field identifiers.

Origin “O” may be identified as a location on check image 200 from which to quantify the relative locations of the segments. For example, origin O may be coincident with the lower left corner of a check upon which check image 200 is based. Axis “x” may run along an edge of the check. For example, axis x may run along the lower edge of the check. Axis “y” may be orthogonal to axis x and may run along an edge of the check. For example, axis y may run along the side edge of the check. Locations of each of the segments may be quantified by coordinates based on the x- and y-axes. For example, the location of a rectangular segment may be quantified as the coordinates of four corners of a rectangle. Any other suitable scheme for quantifying segment locations may be used.

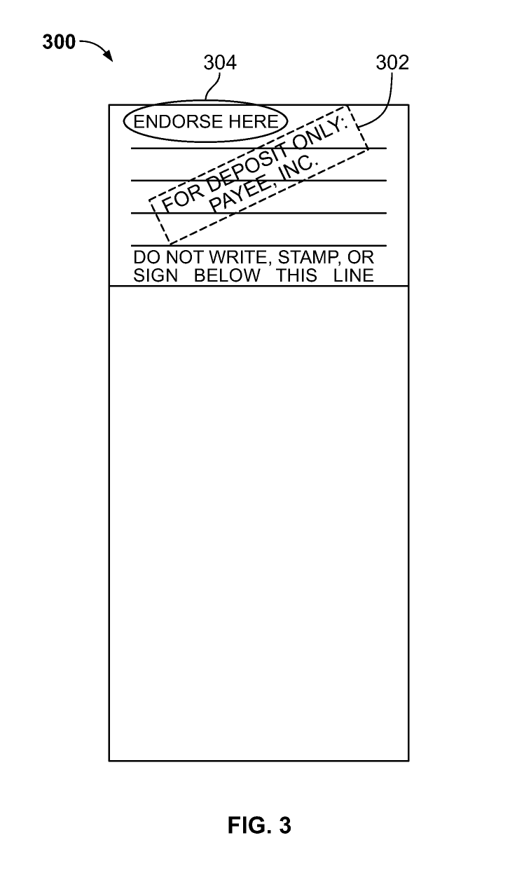

FIG. 3 shows illustrative back check image 300. Back check image 300 may include one or more segments. Each segment may correspond to a type of information that is included on the back of a check. In FIG. 3, check segments are identified by rectangular boxes. For example, back check image 300 may include payee endorsement segment 302 and any other suitable segments.

Back check image 300 may include one or more field identifiers. Each field identifier may correspond to a type of information that is displayed on the check to identify a check segment. For example, check image 300 may include “endorse-here” field identifier 304 and any other suitable field identifiers.

Each of the fields may correspond to a segment of a check. The check may include one or more field identifiers that correspond to the segment. For example, the field identifiers may include “DATE,” “PAY TO THE ORDER OF,” “DOLLARS,” “MEMO” and any other suitable identifiers. Table 1, below, shows illustrative transaction record fields, illustrative corresponding check segments and illustrative corresponding field identifiers.

Table 1 shows illustrative transaction record fields, illustrative corresponding check segments and illustrative corresponding field identifiers.

TABLE 1
Illustrative transaction record fields,
illustrative corresponding check segments and illustrative
corresponding field identifiers.

| | | Illustrative |
|---|---|---|
| Illustrative | | corresponding field |
| transaction record | Illustrative corresponding | identifiers (FIG. |
| fields (FIG. 1 | check segments (FIG. 2 | 2/3 reference |
| reference numeral) | reference numeral) | numeral) |
| Check number (102) | Check number segment (208) | |
| | Check number segment (226) | |
| Account identifier | Customer name segment (202) | |
| (104) | Customer address 1 segment | |
| | (204) | |
| | Customer address 2 segment | |
| | (206) | |
| | Routing number segment | |
| | (222) | |
| | Account number segment | |
| | (224) | |
| Payee (106) | Payee segment (212) | PAY TO THE ORDER OF |
| | Payee endorsement segment | ENDORSE HERE (304) |
| | (302) | |
| Payee family (108) | Payee segment (212) | PAY TO THE ORDER OF |
| | | (232) |
| Check date (110) | Date segment (210) | DATE (230) |
| Check amount (112) | Amount segment (214) | |
| Dollars (114) | Dollars segment (216) | DOLLARS (234) |
| Comment (116) | Comment segment (218) | MEMO (236) |
| Comment family (118) | Comment segment (218) | MEMO (236) |
| Signature (120) | Signature segment (220) | |

Any suitable combination of some or all the information in Table 1 may be transformed into meta-data for use to expedite check processing.

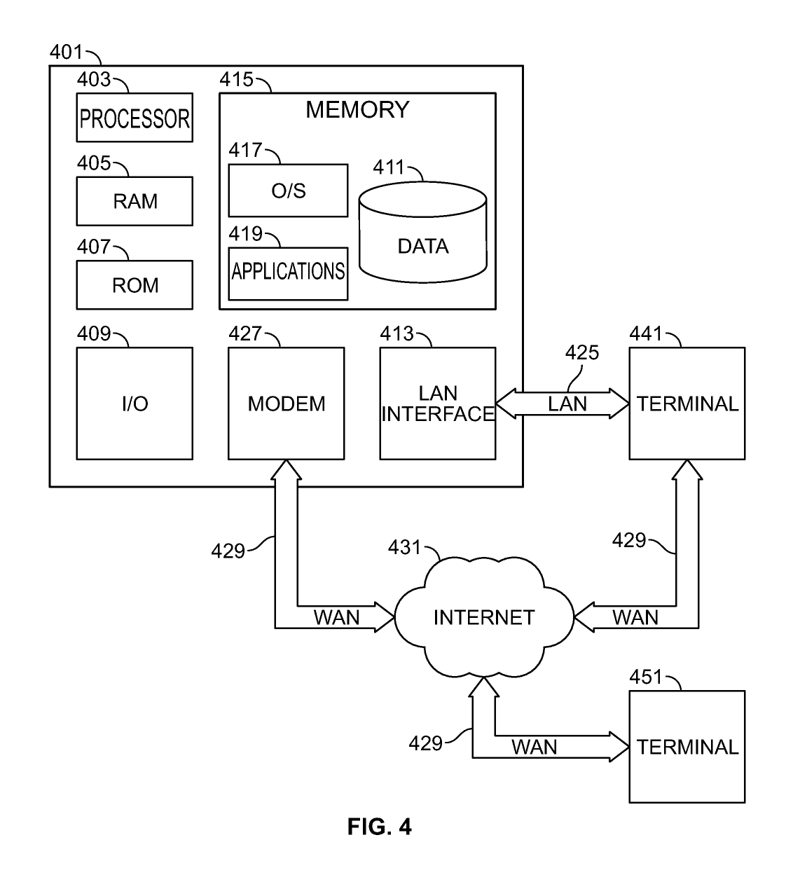

FIG. 4 is a block diagram that illustrates a generic computing device 401 (alternatively referred to herein as a “server”) that may be used in accordance with the principles of the invention. Server 401 may be included in any suitable apparatus that is shown or described herein. Server 401 may have a processor 403 for controlling overall operation of the server and its associated components, including RAM 405, ROM 407, input/output module 409, and memory 415.

Input/output (“I/O”) module 409 may include a microphone, keypad, touch screen, and/or stylus through which a user of device 401 may provide input, and may also include one or more of a speaker for providing audio output and a video display device for providing textual, audiovisual and/or graphical output. Software may be stored within memory 415 and/or storage to provide instructions to processor 403 for enabling server 401 to perform various functions. For example, memory 415 may store software used by server 401, such as an operating system 417, application programs 419, and an associated database 411. Alternatively, some or all of server 401 computer executable instructions may be embodied in hardware or firmware (not shown).

Server 401 may operate in a networked environment supporting connections to one or more remote computers, such as terminals 441 and 451. Terminals 441 and 451 may be personal computers or servers that include many or all of the elements described above relative to server 401. The network connections depicted in FIG. 4 include a local area network (LAN) 425 and a wide area network (WAN) 429, but may also include other networks. When used in a LAN networking environment, computer 401 is connected to LAN 425 through a network interface or adapter 413. When used in a WAN networking environment, server 401 may include a modem 427 or other means for establishing communications over WAN 429, such as Internet 431. It will be appreciated that the network connections shown are illustrative and other means of establishing a communications link between the computers may be used. The existence of any of various well-known protocols such as TCP/IP, Ethernet, FTP, HTTP and the like is presumed, and the system can be operated in a client-server configuration to permit a user to retrieve web pages from a web-based server. Any of various conventional web browsers can be used to display and manipulate data on web pages.

Additionally, application program 419, which may be used by server 401, may include computer executable instructions for invoking functionality related to communication, such as email, short message service (SMS), and voice input and speech recognition applications.

Computing device 401 and/or terminals 441 or 451 may also be mobile terminals including various other components, such as a battery, speaker, and antennas (not shown).

Terminal 451 and/or terminal 441 may be portable devices such as a laptop, cell phone, Blackberry™, or any other suitable device for storing, transmitting and/or transporting relevant information.

Any information described above in connection with database 411, and any other suitable information, may be stored in memory 415.

One or more of applications 419 may include one or more algorithms that may be used to receive check content information from an individual, issue a banking transaction receipt, provide online customer account management tools, provide customer account statements and/or perform any other suitable tasks related to transaction record processing.

The invention may be operational with numerous other general purpose or special purpose computing system environments or configurations. Examples of well known computing systems, environments, and/or configurations that may be suitable for use with the invention include, but are not limited to, personal computers, server computers, hand-held or laptop devices, mobile phones and/or other personal digital assistants (“PDAs”), multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, etc., that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

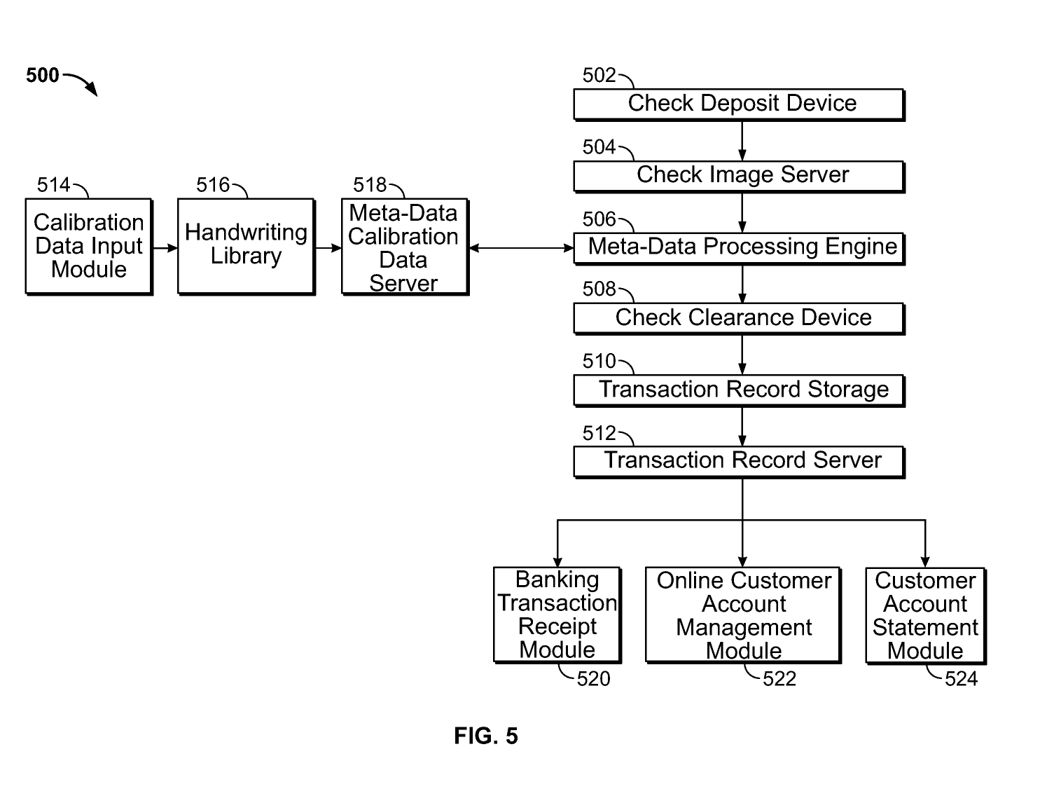

FIG. 5 shows illustrative arrangement 500 for deriving and processing a transaction record based on check content. One or more of the elements of arrangement 500 may include one or more of the features shown in FIG. 4. Arrangement 500 may include check deposit device 502. Check image server 504 may form part of check deposit device 502. Check deposit device may include meta-data processing engine 506. Meta-data processing engine 506 may receive a check image, such as front check image 200 (shown in FIG. 2) or back check image 300 (shown in FIG. 3), from check image server 504.

Handwriting analysis may an important part of the expediting check content process according to certain embodiments. Calibration data input module 514, handwriting module 516 and meta-data calibration server 518 may be used either together or separately to analyze handwriting on a check for use with expediting check content processing according to certain embodiments.

Numerous segments of the check may include handwritten characters. Such segments may include the check date 110, check amount 112, dollars 114 and/or any other suitable segments for use in expediting check processing. Printed character reference text may be use to allow the check deposit device to read handwritten characters on the check.

Printed character reference text for use with module 514 may be derived from printed character text on the check. The customer may provide the printed character reference text. In some embodiments, meta-data processing engine 506 may provide the printed character reference text.

Handwriting library 516 may store handwriting samples and the corresponding printed character reference text. Handwriting library 516 may store, in connection with one or more of the handwriting samples, a numerical function or functions that quantitatively characterize the handwriting sample. Handwriting library 516 may store handwriting samples and corresponding printed character reference text for a plurality of customers.

Handwriting, for use with handwriting library 516, may include cursive or script information written by hand or printed by machine. Printed character text may be block-style letters that are written by hand or printed by machine.

The handwriting sample may be a signature. The signature may be from a signature card that the customer signed to obtain signatory authority for an account. The printed character reference text may be prepared in connection with the signature.

The handwriting sample may be from a check image such as front check image 200 (shown in FIG. 2) or back check image 300 (shown in FIG. 3). The corresponding printed character reference text may be provided by a handwriting decoding algorithm, a financial institution agent, the customer or any other suitable system or individual.

The corresponding printed character reference text may be obtained from a check image such as front check image 200 (shown in FIG. 2) or back check image 300 (shown in FIG. 3). For example, the printed character reference text may be obtained from segment 302 of check image 300. Some or all of the content of segment 302 may correspond to some or all of the content of segment 212 of check image 200.

Meta-data calibration data server 518 may serve handwriting samples to meta-data processing engine 502. Meta-data calibration data server 518 may serve printed character reference text that corresponds to the handwriting samples to meta-data processing engine 506.

Meta-data calibration data server 518 may include a processor (not shown) that compares check segment content to a library handwriting sample. Such a sample may be from checks previously written, and processed from the same drawer.

For example, the processor may receive check segment content from meta-data processing engine 506. The processor may generate one or more numerical functions that correspond to the check segment content. The processor may quantitatively compare the one or more check segment content numerical functions to the one or more handwriting sample numerical functions. The processor may thus identify a handwriting sample that matches or partially matches the check segment content. The match or partial match may be based on an objective function that indicates a degree of likeness between the handwriting sample and the check segment content.

If a match or partial match is found, meta-data calibration data server 518 may provide to meta-data processing engine 506 the printed character reference text that corresponds to the handwriting sample.

Arrangement 500 may include check clearance engine 508. Check clearance engine may preferably be adapted to communicate, either directly or indirectly, with a drawee bank identified on the face of the check.

Check clearance engine 508 may preferably be adapted for determining whether funds sufficient to cover the check exist in an account associated with the check.

Check clearance engine 508 may preferably be adapted for communicating with a central location, a central server, a computer or other device. The communication may preferably be arranged for determining, preferably in real time, whether sufficient funds exist in the account associated with the check for the check to clear.

Arrangement 500 may include transaction record storage 510. Transaction record storage 510 may include one or more transaction records such as transaction record 100 (shown in FIG. 1).

Arrangement 500 may include transaction record server 512. Transaction record server 512 may be configured to deliver the one or more transaction records, or portions thereof, to one or more of banking transaction receipt module 520, online customer account management module 522 and/or customer account statement module 524.

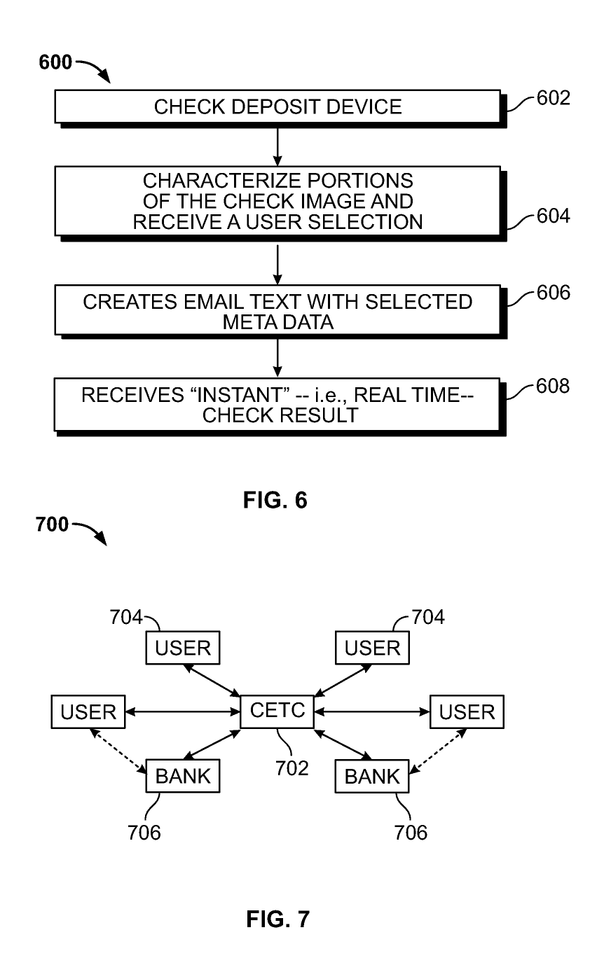

Processes in accordance with the principles of the invention may include one or more features of the processes illustrated in FIGS. 6-8. For the sake of illustration, the steps of the illustrated processes will be described as being performed by a “system.” The “system” may include one or more of the features of the apparatus shown in FIGS. 4 and 5 and/or any other suitable device or approach. The “system” may be provided by an entity. The entity may be an individual, an organization or any other suitable entity. For example, the entity may be a financial institution or an agent of a financial institution.

FIG. 6 shows an illustrative process for use of check-face meta-data for enhanced transaction processing. Step 602 shows using the check deposit device to retrieve an image of a check.

Step 604 shows characterizing the portions of the image of the check as meta-data and receiving a selection from a user to determine, preferably in real time, whether sufficient funds exist in an account associated with the drawee bank to cover the check. Another possible selection offered to the user by the check deposit device may involve depositing the check according to regular check deposit, and clearance protocols.

Step 606 shows, in response to a selection by the user to determine whether sufficient funds exist in an account associated with the drawee bank to cover the check, creating an e-mail, text or other machine-readable message including relevant meta-data. The created e-mail may preferably include data necessary for determining whether a sufficient amount of funds exists in an account associated with the drawee bank to cover the check. Such data may include less or more than the following data points: check number, account identifier (which may or may not include the routing number for the financial institution with which the bank account is associated), payee, payee family, check date, check amount, dollars, signature and/or scan location.

The e-mail may be transmitted from the check deposit device to a central location. The central location may include a computer that is in communication with a number of financial institutions. Alternately, the check deposit device may be in contact directly with the drawee financial institution(s). In certain embodiments of the invention, the routing number on the check for the financial institution and/or the bank account number may form a portion of an e-mail or text message address for use by the check deposit device. The e-mail, or text message, may then be routed either to the central location for distribution to the financial institution, or to the financial institution directly.

One or more financial institutions may opt-in to be part of a service that is accessible from such a check deposit device. Such financial institutions may preferably be available to receive communications regarding whether a sufficient amount of funds exists in an account associated with the drawee bank to cover the check.

It should be noted that even if the check deposit device receives an indication that a sufficient amount of funds currently exists in an account associated with the drawee bank to cover the check, nevertheless, such an indication may not guarantee that a sufficient amount of funds will exist at a later time in an account associated with the drawee bank to cover the check.

In certain embodiments of the invention, a financial institution associated with a central server may act as a guarantor that the funds will be in the drawer's account at some pre-determined time. Such a guarantor may offer such a guarantee preferably only following a confirmation that funds exist in the account at the time of the check deposit's request for information.

In certain embodiments, upon receipt of the request to determine whether sufficient funds exist in the account associated with the check, the drawee bank may place a hold on the amount of funds in the check. The drawee bank may continue to hold the funds pending receipt of the check, and/or check image, for clearance. The drawee bank may continue to hold the funds until the check has cleared and the transfer to the payee has occurred.

In some embodiments, the check deposit device may have a line of communication with each of a number of banks that participate in a group. As described above, the member banks of the group may participate on an opt-in basis.

In such embodiments, the user may select which bank the check is drawn against. Alternatively, the check deposit device may select which bank the check is drawn against based on information on the check. Thereafter, the check deposit device may be in direct communication with the bank associated with the check to determine whether there are sufficient funds in the account associated with the check.

Step 608 shows receiving a determination from the central location and/or financial institution. The determination may indicate that a sufficient amount of funds exists in an account associated with the drawee bank to cover the check. The determination may indicate a sufficient amount of funds does not exist in an account associated with the drawee bank to cover the check. The determination may indicate that the account does not exist. The determination may indicate that the account is associated with fraudulent activity.

In certain embodiments, the check deposit device may require, in order to access the account information, biometric information from either the drawer and/or the payee. Such biometric information may include the drawer's fingerprint and/or the payee's fingerprint, or any other suitable biometric information.

In certain embodiments, the check deposit device may require a Personal Identification Number (“PIN”) from either the drawer or the payee. In such embodiments, the transmission of the check image information—e.g., the meta-data—from the check deposit device may be contingent, at least in part, on receipt of such biometric information and/or such a PIN(s).

FIG. 7 shows an illustrative arrangement 700 for use according to certain embodiments. Such an arrangement preferably uses certain check-face meta-data for enhanced transaction processing.

Illustrative arrangement 700 includes a check e-mail/text center (“CETC”) 702, users 704 and banks 706. Arrangement 700 preferable illustrates that communications between the various parties 704, 706 may be instituted via center 702. In other embodiments (not shown), users 704 may contact banks 706, or other suitable financial institutions, directly via e-mail, text or other suitable electronic communication.

In certain embodiments of CETC 702, a computing device, such as generic computing device 401, may be used. For example, device 401 may obtain check information using a camera and/or scanner which forms part of I/O 409.

Device 401 may obtain meta-data from the check using, for example, processor 403 and applications 419. Thereafter, device 401 (which may act both as a check deposit device and/or a check clearance engine) may transmit meta-data to the drawer bank using either LAN 425, WAN 429 and/or internet 431. Thereafter, device 401 may receive a communication via LAN 425, WAN 429 and/or internet 431 from the drawer bank regarding the sufficiency of the funds in the account identified on the check. Such communication may be used by device to formulate either a video indication and/or an audio indication for communication to the payee. Such an indication may preferably indicate whether funds in the account identified in the check are sufficient to cover the check.

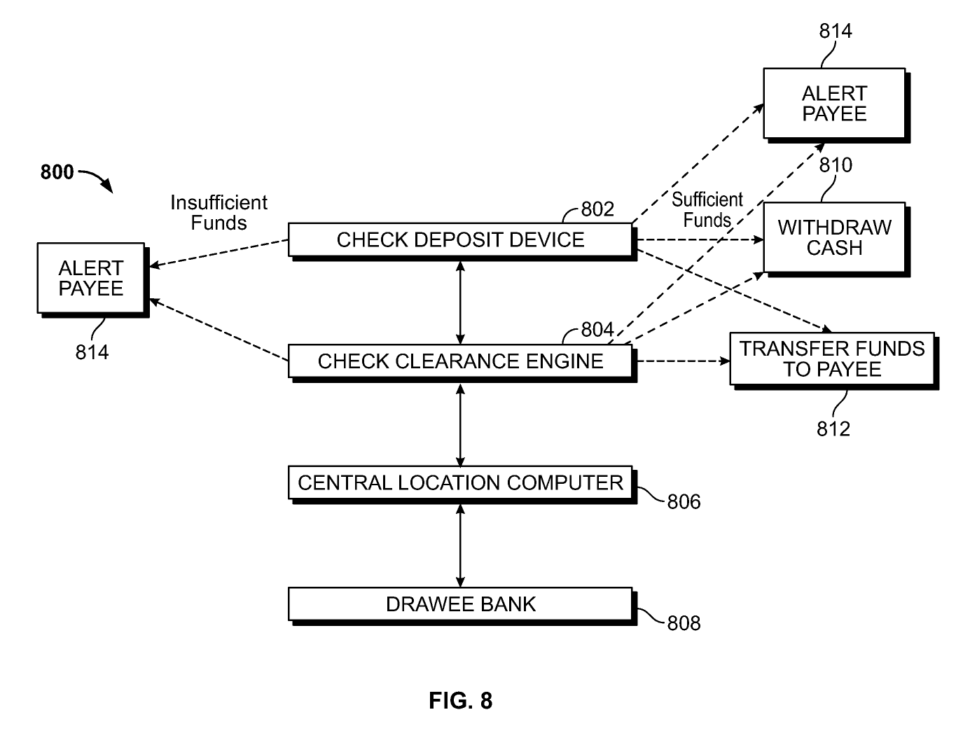

FIG. 8 shows yet another illustrative arrangement 800 for use according to certain embodiments. Arrangement 800 shows check deposit device 802.

Check deposit device preferably receives an image of a check, derives meta-data from the check and forwards at least a portion of the relevant meta-data to check clearance engine 804. Thereafter, check clearance engine 804 transmits at least relevant portions of the meta-data to the central location computer 806.

Central location computer 806 preferably forwards the received meta-data to the drawee bank 808 for confirmation of sufficient funds. Thereafter, central location computer 806 may receive from drawee bank an indication of sufficient funds or insufficient funds.

Upon receipt of either a notification of sufficient funds or insufficient funds, check clearance engine may either relay this information to check deposit device 802 and/or to payee 814. In response to an indication of sufficient funds, then either check deposit device 802 or check clearance engine 804 may transmit an instruction to either cause cash to be withdrawn 810 or to transfer funds to an account specified by payee 812.

Thus, apparatus and methods for deriving a transaction record and using the record for expedited check clearance based on a handwritten check have been provided. Persons skilled in the art will appreciate that the present invention can be practiced by other than the described embodiments, which are presented for purposes of illustration rather than of limitation. The present invention is limited only by the claims that follow.

What is claimed is:

1. A check deposit device for check-face meta-data processing, the apparatus comprising:
an image receiver device that is configured to receive a check image;
a processor device that is configured to:
define a plurality of check segments within the check image;
obtain content from each of the plurality of check segments;
store the content in a machine readable memory;
a transmitter that is configured to transmit the content stored in the machine readable memory to a check-clearance engine; and
a data receiver device that is configured to receive from the check-clearance engine, in response to the transmission of the content, an indication of the sufficiency of funds in an account associated with the check relative to an amount of the check.

2. The check deposit device of claim 1 wherein the plurality of check segments comprises at least three check segments.

3. The check deposit device of claim 1 wherein the plurality of check segments comprises a check number segment.

4. The check deposit device of claim 1 wherein the plurality of check segments comprises an account identifier segment.

5. The check deposit device of claim 1 wherein the plurality of check segments comprises a payee segment and a payee family segment.

6. The check deposit device of claim 1 wherein the plurality of check segments comprises a check date segment.

7. The check deposit device of claim 1 wherein the plurality of check segments comprises a dollars segment.

8. The check deposit device of claim 1 wherein the plurality of check segments comprises a signature segment.

9. The check deposit device of claim 1 wherein the plurality of check segments comprises a scan location segment.

10. The check deposit device of claim 1 further comprising a cash dispenser device, wherein the processor is further configured to dispense cash in response, at least in part, to the data receiver device receiving confirmation of sufficiency of funds and at least in part to receiving a user request to dispense cash.

11. The check deposit device of claim 1 further comprising a deposit device, wherein the processor is further configured to instruct the deposit device to receive a deposit of funds corresponding to an amount of funds written on the check in response, at least in part, to the data receiver device receiving confirmation of sufficiency of funds and at least in part to receiving a user request to deposit funds corresponding to an amount of funds written on the check.

12. The check deposit device of claim 10, wherein the processor is further configured, upon receipt of identification of the payor and upon receipt confirmation of sufficiency of funds, to convert a check transaction into an automated clearinghouse (“ACH”) transaction.

13. The check deposit device of claim 1, wherein the check-clearance engine is in communication with a drawee bank upon which the funds in the check are drawn.

14. The check deposit device of claim 12, wherein the check-clearance engine's communication with the drawee bank conforms to an X9 standard for a check image.

15. The check deposit device of claim 1, wherein the check deposit device comprises the check clearance engine.

16. The check deposit device of claim 1, wherein the check deposit device is separate from, and in communication with, the check clearance engine.

17. One or more, non-transitory, computer-readable media storing computer-executable instructions which, when executed by a processor on a computer system, perform a method for using a check deposit device to process a check, the method comprising:
deriving meta-data from the check, the check deposit device configured to:
obtain a check image from the check, the obtaining using an image receiver device;
define a plurality of check segments within the check image, said defining using the processor device;
obtain content from each of the plurality of check segments, said obtaining using the processor device;
store the content of each of the plurality of check segments in a machine readable memory, said storing using the processor device;
transmitting the content from plurality check segments stored in the machine readable memory to a check-clearance engine; and
receiving from the check-clearance engine, in response to the transmission of the content from the plurality of check segments, an indication of the sufficiency of funds in an account associated with the check relative to an amount of the check.

18. The media of claim 17 wherein the plurality of check segments comprises an account identifier segment.

19. The media of claim 17 wherein the processor is further configured to dispense cash in response, at least in part, to a data receiver device receiving confirmation of sufficiency of funds and at least in part to receiving a user request to dispense cash.

20. The media of claim 18, wherein the check deposit device further comprises a deposit device, wherein the processor is further configured to instruct the deposit device to receive a deposit of funds corresponding to an amount of funds written on the check in response, at least in part, to the data receiver device receiving confirmation of sufficiency of funds and at least in part to receiving a user request to deposit funds corresponding to an amount of funds written on the check.

21. The media of claim 17, wherein the processor is further configured, upon receipt of identification of the drawer and upon receipt confirmation of sufficiency of funds, to inform the payee by e-mail or text of sufficiency of funds, wherein the address of the e-mail or text includes a drawer's bank routing number and/or a bank deposit number of the account associated with the check.
